(19) United States
(12) Patent Application Publication
(10) Pub. No.: US 2012/0183714 A1
(43) Pub. Date: Jul. 19, 2012

(54) MULTI-FUNCTION REUSABLE STICKER TEACHING TOOL

(76) Inventor: Catherine Hsui-Feng Peng, Kaohsiung (TW)

(21) Appl. No.: 13/008,010

(22) Filed: Jan. 17, 2011

(51) Int. Cl. B32B 7/12

(52) U.S. Cl. 428/41.8; 428/343

(57) ABSTRACT

A multi-function reusable sticker teaching tool, comprising a pad body, a first pressure-sensitive adhesive layer and a second pressure-sensitive adhesive layer. The pad body has a front surface and a back surface. The first pressure-sensitive adhesive layer is disposed on the back surface of the pad body for attachment to a wall. The second pressure-sensitive adhesive layer is disposed on the front surface of the pad body in a specific pattern for attachment to a sheet material. The first and second pressure-sensitive adhesive layers both have reusable sticking and water-proof properties, and the surface area of the second pressure-sensitive adhesive layer is smaller than that of the first pressure-sensitive adhesive layer. Therefore, the front and back surfaces can be adhered repeatedly and multiple fixing functions can be integrated. Furthermore, it's suitable as a teaching aid with the advantages of a simplified structure, small volume, and is easily moved to change the position of the tool and replace teaching content.

### FIELD OF THE INVENTION

The present invention generally relates to an educational or demonstrational appliance, and more specifically to a multi-functional reusable sticker teaching tool.

### BACKGROUND OF THE INVENTION

It is common to use different sizes and types of teaching materials when teaching infants or children, such as flash cards, vocabulary cards, category cards, toy bags, posters, or whiteboard markers and color markers, etc. For example, flash cards have words and related pictures to explain and help children to remember words. Usually different types of teaching materials are sorted and collected in a pocket chart. During teaching, the pocket chart is unfolded and fixed on a wall or display board to display and interact with infants or children.

There are many ways to fix the teaching materials on the wall or display board, such as using a screw or nail to hang the pocket chart, using tape to post flash cards, or even using magnets. However, these above methods all have the following disadvantages as follows:

1. Since holes are left on the wall when using screws or nails, the surface of the wall is destroyed, and presentation location cannot later be changed.

2. Glue is left behind on the surface of a wall when using tape and flash cards may be damaged when the picture cards are torn off. This can create an unsightly surface on the wall.

3. Magnets are not suitable for the affixing of all teaching materials and are easily dropped, since magnets frequently do not have sufficient supporting strength to hold heavy objects, and further, magnets cannot be fixed onto conventional concrete walls.

Therefore, different teaching materials must use corresponding appropriate fixing tools to fix them on a wall. For instance, using hooks for bags, using tape or thumbtacks for posters, and using tape or magnets for flash cards, etc. It is not convenient to prepare and carry these different kinds of fixing tools, and costs related to such fixing tools create additional expenses.

### SUMMARY OF THE INVENTION

It is an object of the present invention to provide a multi-function reusable sticker teaching tool having front and back surfaces which can be adhered repeatedly and with which multiple fixing functions can be integrated. Embodiments are suitable for teaching assistance providing the advantages of a simplified structure, small volume, and which may be easily moved to change the tool position and teaching content.

It is another object of the present invention to provide a multi-function reusable sticker teaching tool suitable for multiple ways of affixing objects, providing more diversified and lively displays and teaching.

It is the other object of the present invention to provide a multi-function reusable sticker teaching tool that does not cause damage when moved from a wall and leaves behind no residue that would otherwise affect the appearance of the wall. Furthermore, if the adhesive ability is reduced or the tool is dirty, the tool can be cleaned with water and dried for reuse and is thus environmentally friendly.

According to an embodiment of the present invention, a multi-function reusable sticker teaching tool comprises a pad body, a first pressure-sensitive adhesive layer and a second pressure-sensitive adhesive layer. The pad body has a front surface and a back surface. The first pressure-sensitive adhesive layer is disposed on the back surface of the pad body for attaching to a wall. The second pressure-sensitive adhesive layer is partially disposed on the front surface of the pad body for attachment of a sheet material. The first pressure-sensitive adhesive layer and the second pressure-sensitive adhesive layer both have reusable sticking and water-proof properties, and the area of the second pressure-sensitive adhesive layer is smaller than that of the first pressure-sensitive adhesive layer.

The multi-function reusable sticker teaching tool according to the present invention has the following advantages and effects:

1. Through disposing the pressure-sensitive adhesive layers on the front and back surface of the pad body with different patterns as a technical means, the front and back surfaces of the pad body can be adhered repeatedly and multiple fixing functions can be provided. Embodiments are suitable for teaching assistants with the advantages of a simplified structure, small volume, easily movable to change the tool position and swap out teaching content.

2. Through disposing the pressure-sensitive adhesive layers on the front and back surfaces of the pad body, disposing a hanger and card holder on the front surface as a technical means, one single tool can be suitable for various fixing methods such as hanging by hooks, the horizontal rods or cords, adhesives and mechanisms for replacing cards. Accordingly, display and teaching can be more diversified and lively.

3. Through disposing the pressure-sensitive adhesive layer on the back surface of the pad body as a technical means, there is no damage when peeling from the wall and there is no residue left behind on the wall to affect the appearance of the wall. Furthermore, the tool can be cleaned with water and dried for reuse when the tool has reduced adhesive abilities or becomes dirty, with consequent environmental effects.

4. Through the pad body, the first pressure-sensitive adhesive layer and the second pressure-sensitive adhesive layer made of flexible, soft materials, embodiments are suitable for both flat and curved walls to achieve firm adherence and positioning.

### DESCRIPTION OF THE DRAWINGS

FIG. 1 is a perspective view of a multi-function reusable sticker teaching tool according to a first embodiment of the present invention.

FIG. 2 is an exploded view of separable elements of the tool of FIG. 1.

FIG. 3 is a cross-sectional view of the tool of FIG. 1 after attaching to a wall.

FIG. 4 is a perspective view of the tool of FIG. 1 in use in a teaching situation hanging a teaching material and setting a card at the same time.

FIG. 5 is a front view of the tool of FIG. 1 in another teaching situation attaching a teaching material and placing a teaching stick at the same time.

FIG. 6 is a front view of the tool of FIG. 1 in another teaching situation hanging a teaching material with a hanger.

FIG. 7 is a perspective view of the tool of FIG. 1 in another teaching situation hanging a teaching material with a hanging rod.

FIG. 8 is a perspective view of the tool of FIG. 1 in another teaching situation placing a pen and attaching a sheet material at the same time.

FIG. 9 is a perspective view of another multi-function reusable sticker teaching tool according to a second embodiment of the present invention.

### DETAILED DESCRIPTION OF THE INVENTION

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor in the actual ratios. Some of the dimensions or dimension ratios have been enlarged or simplified to provide better illustrations. The actual numbers, actual shapes, or actual dimension ratios can be selectively designed and disposed and the detail component layouts may be more complicated.

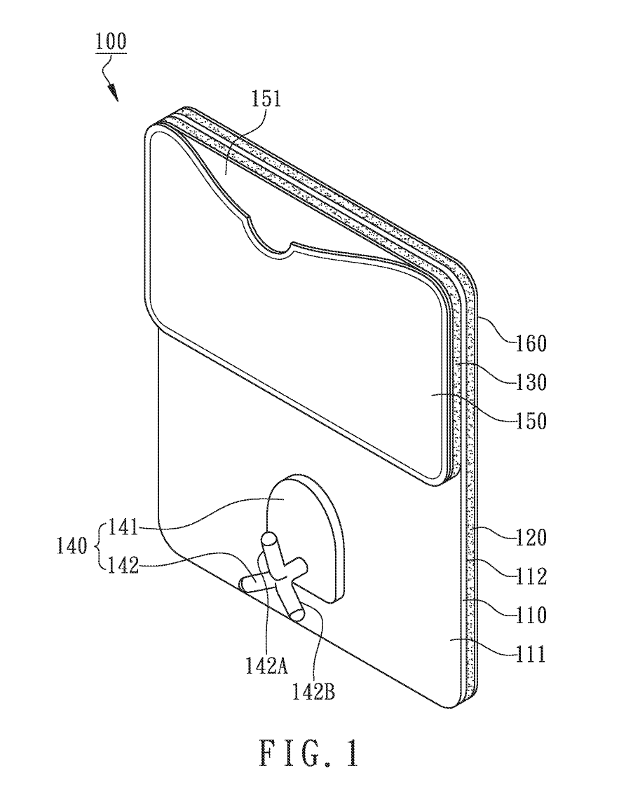

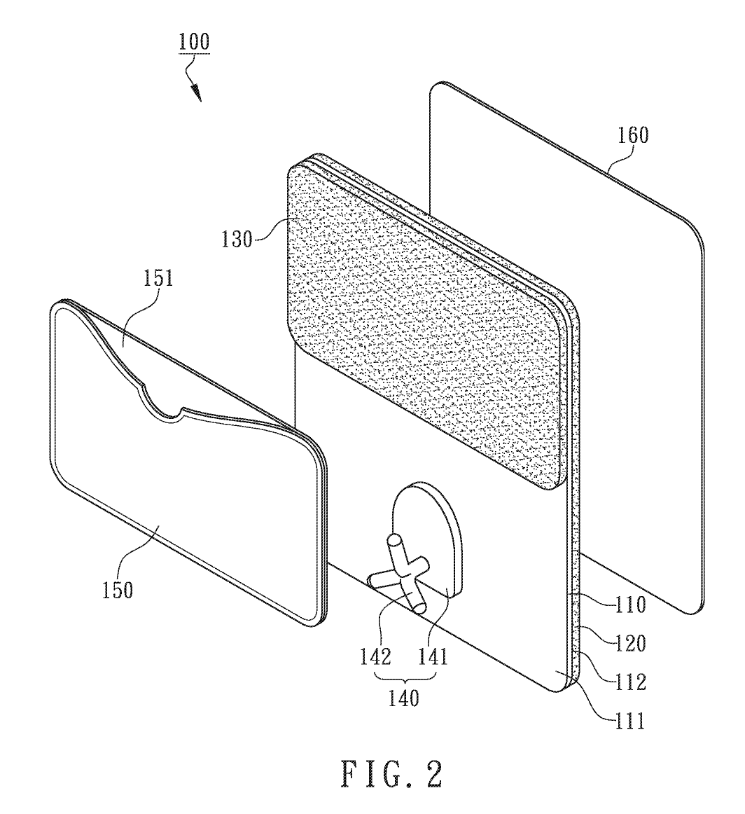

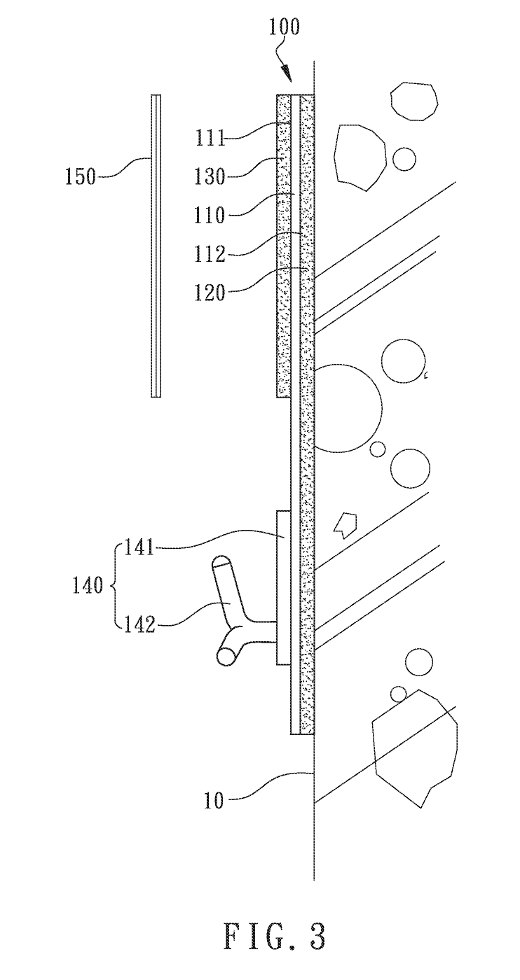

According to the first embodiment of the present invention, a multi-functional reusable sticker teaching tool is illustrated in FIG. 1 in a perspective view, in FIG. 2 in an exploded view and in FIG. 3 in a cross-sectional view. The multi-functional reusable sticker teaching tool 100 comprises a pad body 110, a first pressure-sensitive adhesive layer 120 and a second pressure-sensitive adhesive layer 130.

The pad body 110 has a front surface 111 and a back surface 112. The pad body 110 can be formed in various desired shapes from plastic sheet material, such as rectangles, stars, circles or all kinds of cartoon patterns. To be described in detail, the pad body 110 may be a multi-layer structure including a plastic sheet layer, a printed pattern layer and a resin glue layer with a water-proofing effect. If desired, various types of artistic patterns may be printed on the printed pattern layer in the pad body 110. The plastic sheet layer may be made of a transparent plastic material leaving the printed pattern layer visible. In a specific structure, the size of the pad body 110 is 10×10 cm2 so that the multi-function reusable sticker teaching tool 100 has an optimal surface tension.

As shown in FIG. 2 and FIG. 3, the first pressure-sensitive adhesive layer 120 is disposed on the back surface 112 of the pad body 110 for attaching to a wall 10. To be described in detail, the wall 10 is a vertical surface inside a building such as a surface of concrete, glass, wood, tile, plastic, slate, stainless steel, coated sheets and acrylic sheets, or a vertical surface of a display board, blackboard, hanging sheet or stand. Preferably, the wall 10 is a dry, clean and level building surface to avoid the need to install a hanging rack or hanging board. The multi-function reusable sticker teaching tool 100 can be firmly attached onto the wall 10 by way of the first pressure-sensitive adhesive layer 120.

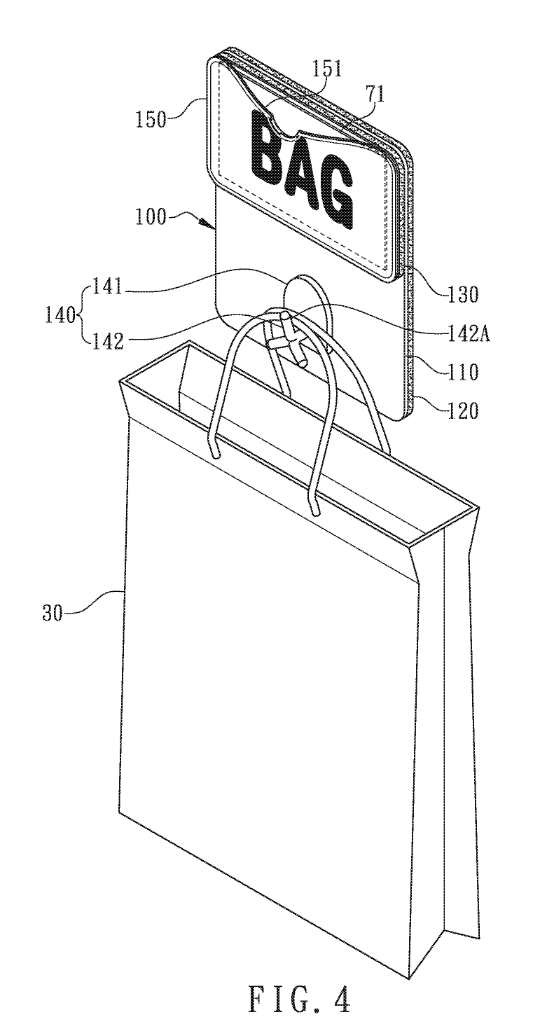

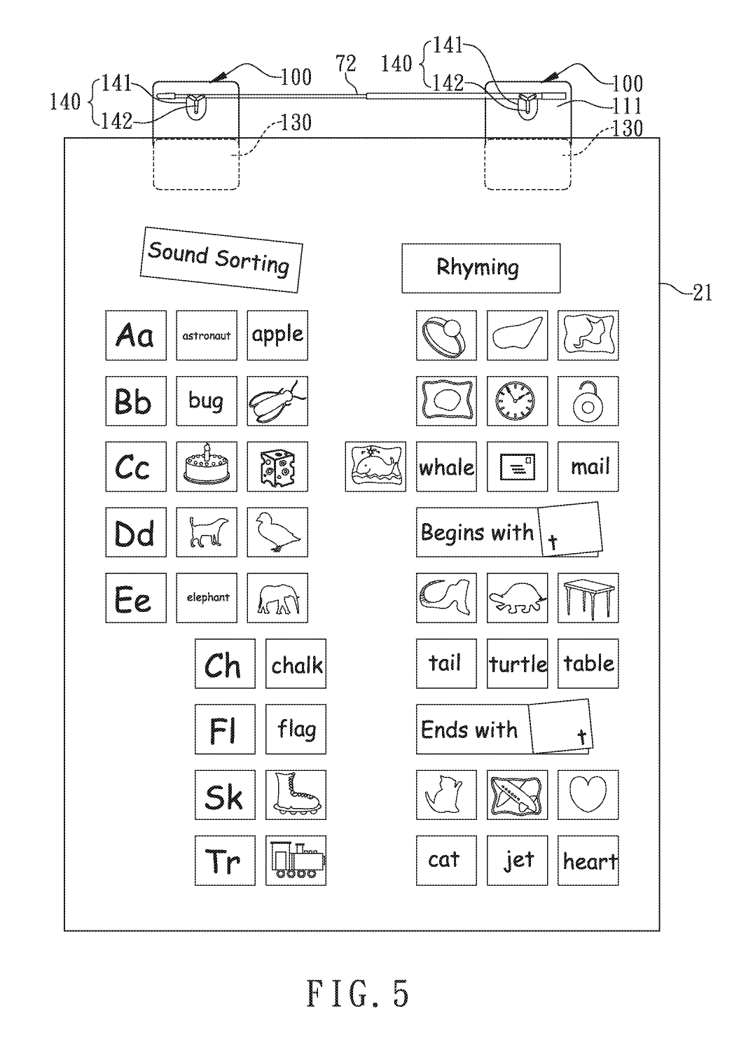

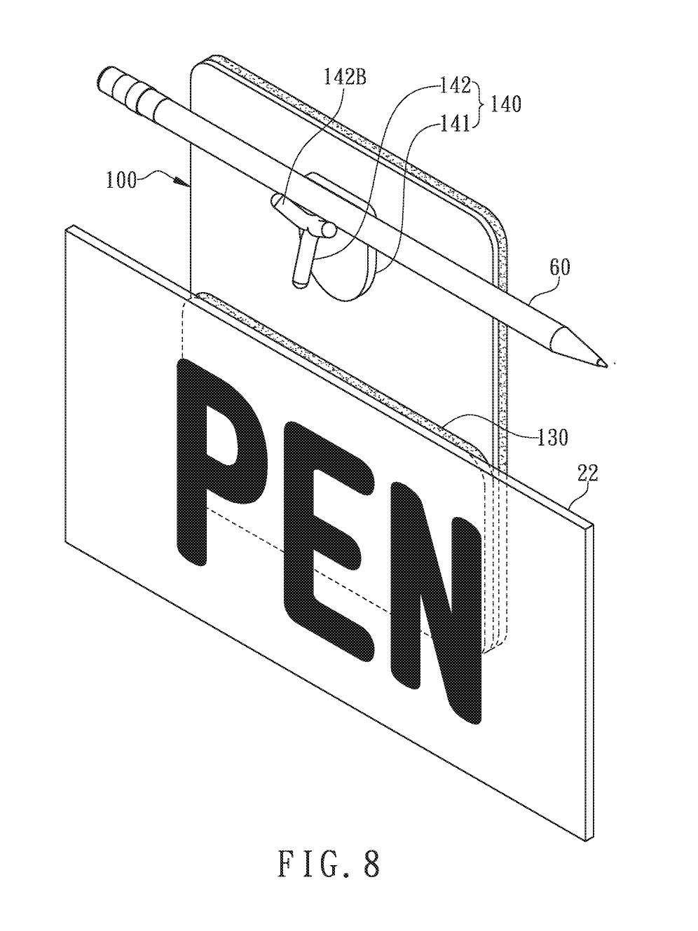

As shown in FIG. 2 and FIG. 3, the second pressure-sensitive adhesive layer 130 is disposed on a portion of the front surface 111 of the pad body 110. As shown in FIG. 5 and FIG. 8, the second pressure-sensitive adhesive layer 130 can be used for attaching a sheet material 21 or 22. The sheet material can be all kinds of thin-shaped articles such as a pocket chart of teaching material, an A4 folder, a drawing paper, a message paper, a handbill or a card element including a flash card, a vocabulary card or a signing card, etc. To be more specific, as shown in FIG. 1 to FIG. 4, the multi-function reusable sticker teaching tool 100 further comprises a card holder 150 which is adhered to the second pressure-sensitive adhesive layer 130. The shape and size of the card holder 150 are both similar to the second pressure-sensitive adhesive layer 130 to completely cover the second pressure-sensitive adhesive layer 130. When the second pressure-sensitive adhesive layer 130 does not need to attach the sheet material or not yet, the card holder 150 is pre-attached onto the second pressure-sensitive adhesive layer 130 to protect the second pressure-sensitive adhesive layer 130 from collecting dust or other debris. Preferably, the card holder 150 is transparent and completely covers the second pressure-sensitive adhesive layer 130 to provide the protection effects of release paper and also to make a card or a name tag set inside the card holder 150 easily visible. To be described in detail, the card holder 150 can be a reverse U-shaped pocket structure with an opening 151 to place various cards 71 (as shown in FIG. 4) for the application of displaying and teaching.

The first pressure-sensitive adhesive layer 120 and the second pressure-sensitive adhesive layer 130 both have reusable adhesive and water-proof properties, and the surface area of the second pressure-sensitive adhesive layer 130 is less than that of the first pressure-sensitive adhesive layer 120 to control the viscosity of the second pressure-sensitive adhesive layer 130 to be less than the viscosity of the first pressure-sensitive adhesive layer 120. To be described in detail, the first pressure-sensitive adhesive layer 120 can completely cover the back surface 112 of the pad body 110, and the surface area of the second pressure-sensitive adhesive layer 130 is not greater than one half of the surface are of the front surface 111 of the pad body 110. When the card holder 150 or the sheet material is torn off from the front surface 111, the pad body 110 is not peeled from the wall. Furthermore, a portion of the front surface 111 of the pad body 110 that is without the second pressure-sensitive adhesive layer 130 may be used for fixing hangers or other applications.

To be more specific, the first pressure-sensitive adhesive layer 120 and the second pressure-sensitive adhesive layer 130 are made of thermoplastic elastomers (TPE). The forming method of the pressure-sensitive adhesive layer is to use plastic-pellet elements and cause them to be melted in the thermosetting resin into a liquid by heating. Then, the front surface 111 and the back surface 112 of the pad body 110 are coated with the liquid, and the coated films are formed after curing. In use, the multi-function reusable sticker teaching tool 100 is attached to the wall by utilizing plastic vacuum suction caused from thermoplastic molecule polymerization inside the plastic-pellet elements. Therefore, the first pressure-sensitive adhesive layer 120 and the second pressure-sensitive adhesive layer 130 have the properties of high elasticity, high strength and high resilience as rubber and have the characteristics of injection molding. The multi-function reusable sticker teaching tool 100 is peeled from the wall without damaging the surface of the wall, and there is no colloid or residue left on the wall to affect the appearance of the wall. Furthermore, the front and back surface of the multi-functional reusable sticker teaching tool 100 both can attach to any place repeatedly and change the card of the front surface limitless times. When the multi-function reusable sticker teaching tool 100 has reduced adhesive abilities or becomes dirty, the multi-function reusable sticker teaching tool 100 can be cleaned with water and dried for reuse, and is thus environmentally friendly. In addition, preferably, the pad body 110, the first pressure-sensitive adhesive layer 120 and the second pressure-sensitive adhesive layer 130 are made from soft, flexible materials, therefore, they are suitable for flat and curved wall surfaces to achieve firm adherence and positioning.

The size of sheet material attached by the second pressure-sensitive adhesive layer 130 is not limited in this present invention. In one embodiment, as shown in FIG. 8, the sheet material 22 adhered onto the second pressure-sensitive adhesive layer 130 is an English vocabulary card. The sheet material 22 is slightly greater than the size of the second pressure-sensitive adhesive layer 130, and is adhered repeatedly and changed. In a different embodiment, as shown in FIG. 5, the sheet material 21 adhered onto the front surface 111 of the pad body 110 is a bag or pocket chart of teaching materials or a large teaching poster, whose sizes are both dozens of times greater than the multi-functional reusable sticker teaching tool 100. After attaching two the multi-function reusable sticker teaching tools 100 to a wall, facing the side of the front surface 111 forming the second pressure-sensitive adhesive layer 130 downward, the sheet material 21 is adhered to the position of the second pressure-sensitive adhesive layer 130 to fix the sheet material 21 on the wall. Preferably, a pointer 72 can be placed on a hanger 140. During teaching, the teacher can easily pick up and replace the pointer 72 so that the multi-function reusable sticker teaching tool 100 can be regarded as a teaching assistant.

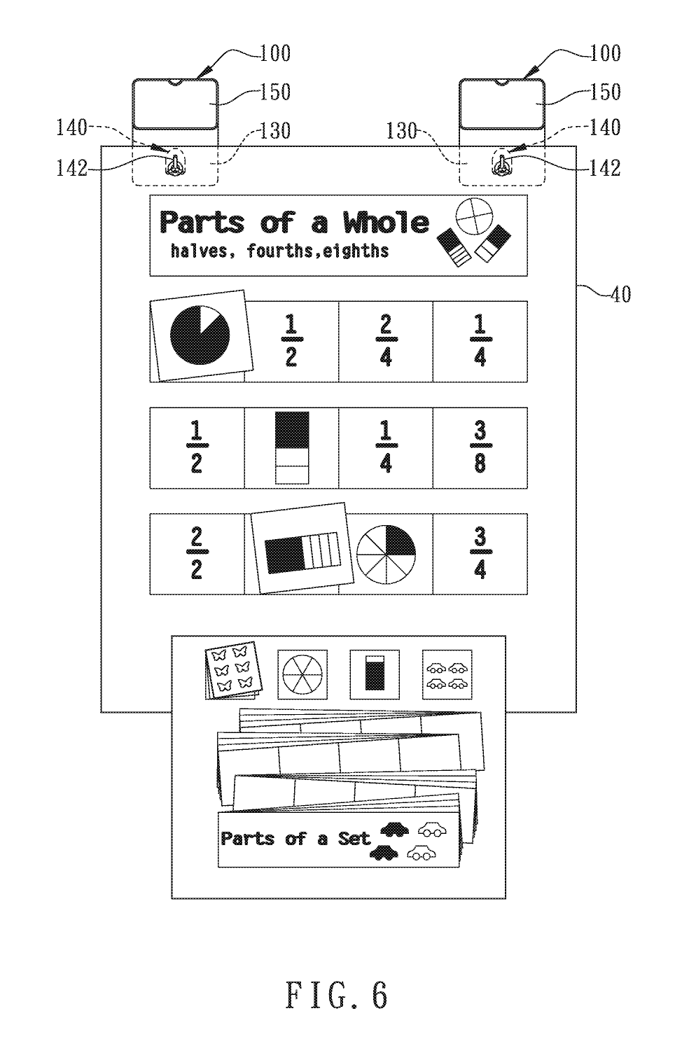

To be more specific, as shown in FIG. 2 and FIG. 4, the multi-function reusable sticker teaching tool 100 can further comprise a hanger 140 fixed to a portion of the front surface 111 of the pad body 110 without forming the second pressure-sensitive adhesive layer 130 for hanging a teaching material 30. In one embodiment, the teaching material 30 is a bag. During teaching, the English word card 71 showing “BAG” is inserted in the card holder 150, and the bag 30 is hung by a main hook 140A of the hanger 140 to perform pair teaching and testing for actual items and English word cards. In other embodiments, as shown in FIG. 6, the hanger 140 of the multi-function reusable sticker teaching tool 100 can be used to hang a large teaching material 40 such as a pocket chart of teaching materials, a large poster or a picture. In the meantime, two multi-function reusable sticker teaching tools 100 can be attached to the wall in parallel, and then the hanging loop or hanging wire of the teaching material 40 is hooked by the hangers 140 to firmly fix for display and teaching purposes

To be described in detail, as shown in FIG. 1, the hanger 140 comprises a joining part 141 and a hook part 142. The joining part 141 is combined with the pad body 110 and protrudes from the front surface 111. The hook part 142 extends outward from the joining part 141 to provide a bent-hook shape. The hook part 142 has at least a main hook 142A toward the center of the pad body 110, and the hook part 142 can be integrally-formed with the joining part 141 to avoid separation and breaking. To be more specific, when the multi-function reusable sticker teaching tool 100 is in the forward condition for attaching, the hanger 140 is disposed on the lower part of the pad body 110 and the main hook 142A of the hook part 142 faces upward. The hanger 140 has a loading ability from 2 to 8 kg through the first pressure-sensitive adhesive layer 120 to prevent the pad body 110 from peeling. Specifically, the loading ability of the hanger 140 is 2.5 kg, and the maintenance time after hanging can be as long as from several weeks to one month, sufficient to hold the weight of typical teaching materials for teaching purposes.

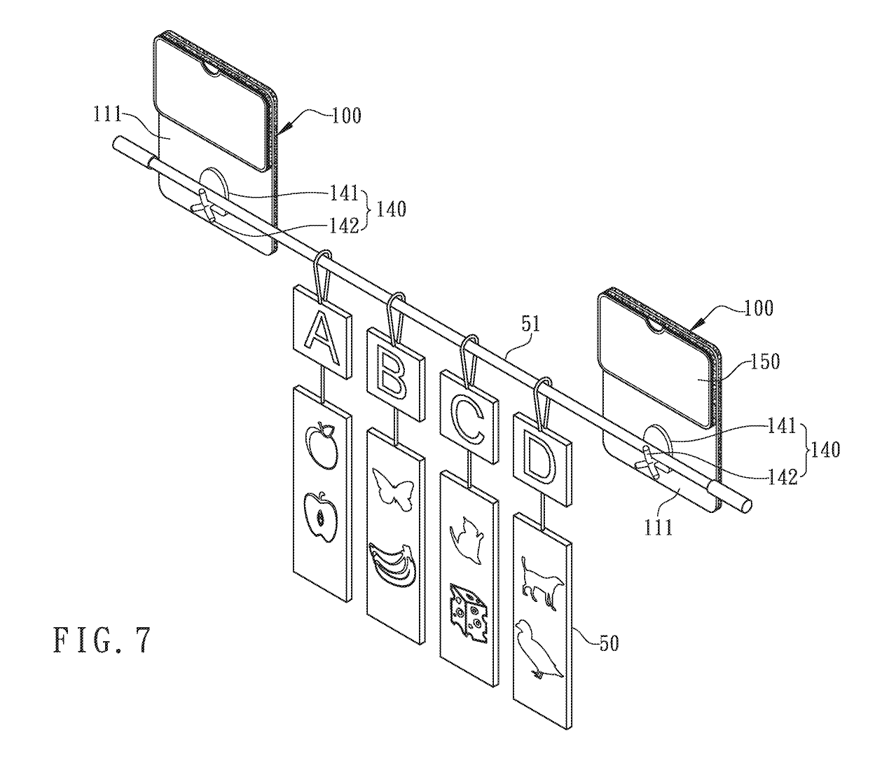

Preferably, the hanger 140 is a reverse Y-shaped device with three hooks, wherein one hook bends upward for the main hook 142A toward the center of the pad body 110, and the others bend downward as the secondary hooks 142B away from the center of the pad body 110. Therefore, two hooks of the hanger 140 can face toward an adjacent edge of the front surface 111 without forming the second pressure-sensitive adhesive layer 130. As shown in FIG. 4, FIG. 6 and FIG. 7, when the pad body 110 is in the forward condition for attaching, one hook of the hanger 140 toward the center of the pad body 110 can bear the heavier loading weight. As shown in FIG. 7, a hanging rod 51 of the teaching material 50 can be firmly supported by two multi-function reusable sticker teaching tools 100, and the word cards and the flash cards of the teaching material 50 are further hanged on the hanging rod 51. In another embodiment, a cord is connected between two hangers 140, and clips can be set on the cord for clipping a plurality of word cards to provide a teaching material. Moreover, in another embodiment, the hook part 142 may also have one hook. When large or small teaching materials are hung, two multi-functional reusable sticker teaching tools 100 may be used for hanging purposes.

Although the load of the secondary hook 142B is lower than the load of the main hook 142A, the rod-shaped matter can be placed horizontally. As shown in FIG. 8, when the teaching material 60 is a pen or a rod, the pad body 110 can be in a reversed orientation for attaching where the two secondary hooks 142B away from the center of the pad body 110 are utilized to place a pen 60, so two hooks of the hanger 140 can firmly support a lighter rod. Furthermore, as shown in FIG. 8, a sheet material 22 such as a word card is adhered to the second pressure-sensitive adhesive layer 130, and the word card can be changed to match the corresponding matter on the hanger 140.

As shown in FIG. 2, the multi-function reusable sticker teaching tool 100 further comprises a release paper 160 adhered to the back surface of the first pressure-sensitive adhesive layer 120. The shape and size of the release paper 160 are both similar to the first pressure-sensitive adhesive layer 120 to protect the first pressure-sensitive adhesive layer 120 from adhering to dust or other debris. After tearing off the release paper 160, the multi-function reusable sticker teaching tool 100 can be used to attach to a wall.

Therefore, the multi-function reusable sticker teaching tool 100 through disposing the pressure-sensitive adhesive layers 120 and 130 on the front and back surfaces of the pad body 110, so that the front and back surfaces can be adhered repeatedly and provide multiple integrated fixing functions, is suitable as a teaching assistant and provides the advantages of a simple structure, small volume, portability and replaceable content. Moreover, the multi-function reusable sticker teaching tool 100 can use one single tool can be suitable for various fixing ways such as hanging by the hook, the horizontal rod or cord, adhering and mechanism for replacing the card. Accordingly, display and teaching can be more diversified and lively.

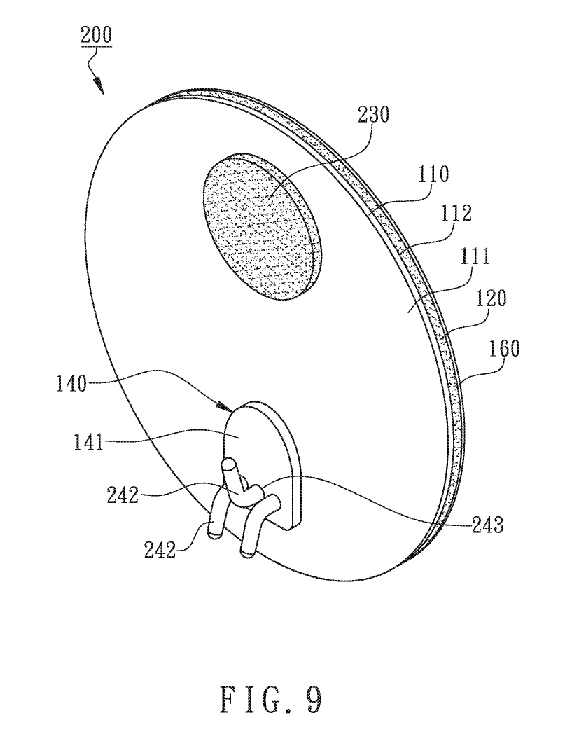

According to the second embodiment of the present invention, another multi-function reusable sticker teaching tool is illustrated in FIG. 9 in a perspective view. The multi-function reusable sticker teaching tool 200 comprises a pad body 110, a first pressure-sensitive adhesive layer 120 and a second pressure-sensitive adhesive layer 230, where the described names and numbers of the major components with the same functions will be the same as in the first embodiment and which will not be described again.

In the present embodiment, the shape of the pad body 110 can be circular, and appropriate printed pattern can be matched to be more artistic. The shapes of the first pressure-sensitive adhesive layer 120 and the release paper 160 are similar to the pad body 110 as circular to completely cover the pad body 110. The second pressure-sensitive adhesive layer 230 has a block pattern without extending to a periphery of the front surface 111 of the pad body 110. Therefore, when the sheet material or a card holder is adhered to the second pressure-sensitive adhesive layer 230, a gap without the second pressure-sensitive adhesive layer 230 is formed between the sheet material and the pad body 11, so that the adhered matters such as the sheet material or card holder can be easily torn off by hand. Furthermore, as a result of the second pressure-sensitive adhesive layer 230 without extending to a periphery of the front surface 111 of the pad body 110, the point of application does not directly affect the edge of the first pressure-sensitive adhesive layer 120 during tearing off of the sheet material at the start. Therefore, the adhesion force of the first pressure-sensitive adhesive layer 120 is not influenced. Even if the sheet material is torn off in any direction and by any force, the pad body 110 is not peeled from the wall.

The above description of embodiments of this invention is intended to be illustrative but not limited. Other embodiments of this invention will be obvious to those skilled in the art in view of the above disclosure which still will be covered by and within the scope of the present invention even with any modifications, equivalent variations, and adaptations.

What is claimed is:

1. A multi-function reusable sticker teaching tool comprising:
a pad body having a front surface and a back surface;
a first pressure-sensitive adhesive layer disposed on the back surface of the pad body for attaching to a wall; and
a second pressure-sensitive adhesive layer disposed on a portion of the front surface of the pad body for attaching a sheet material;
wherein the first pressure-sensitive adhesive layer and the second pressure-sensitive adhesive layer both have reusable adhesive and water-proof properties, and the surface area of the second pressure-sensitive adhesive layer is less than the surface area of the first pressure-sensitive adhesive layer.

2. The tool as claimed in claim 1, wherein the first pressure-sensitive adhesive layer completely covers the back surface of the pad body, and the surface area of the second pressure-sensitive adhesive layer is not greater than one half of the front surface of the pad body.

3. The tool as claimed in claim 1, wherein the second pressure-sensitive adhesive layer has a block pattern that does not extend to a periphery of the front surface of the pad body.

4. The tool as claimed in claim 1, wherein the first pressure-sensitive adhesive layer and the second pressure-sensitive adhesive layer are made of a thermoplastic elastomer.

5. The tool as claimed in claim 4, wherein the pad body, the first pressure-sensitive adhesive layer and the second pressure-sensitive adhesive layer are formed from flexible materials.

6. The tool as claimed in claim 1, further comprising a hanger fixed to a portion of the front surface of the pad body for hanging a teaching material, and the hanger has a loading ability from 2 to 8 kg.

7. The tool as claimed in claim 6, wherein the loading ability of the hanger is 2.5 kg.

8. The tool as claimed in claim 6, wherein the hanger is reverse Y-shaped with three hooks.

9. The tool as claimed in claim 8, wherein two hooks of the hanger face toward an adjacent edge of the front surface.

10. The tool as claimed in claim 1, further comprising a card holder adhered to the second pressure-sensitive adhesive layer.

11. The tool as claimed in claim 10, wherein the card holder completely covers the second pressure-sensitive adhesive layer.

12. The tool as claimed in claim 11, wherein the card holder is transparent.

13. The tool as claimed in claim 10, further comprising a release paper adhered to the first pressure-sensitive adhesive layer.

14. The tool as claimed in claim 6, wherein the tool further comprises the teaching material.
